(19) United States
(12) Patent Application Publication
(10) Pub. No.: US 2007/0253424 A1
(43) Pub. Date: Nov. 1, 2007

(54) Web-based system and method of establishing an on-line meeting or teleconference

(76) Inventors: Christopher F. Herot, Newton Highlands, MA (US); Onur Mergen, Arlington, MA (US); Bernard P. Costello, Brighton, MA (US); Charles J. Digate, Winchester, MA (US); Carol A. Harris, Concord, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/799,329

(22) Filed: May 1, 2007

Related U.S. Application Data
(60) Provisional application No. 60/796,366, filed on May 1, 2006.

(51) Int. Cl. H04L 12/56; H04L 12/16

(52) U.S. Cl. 370/395.2; 370/260

(57) ABSTRACT

A real-time communications system for initiating a real-time communications session involving a plurality of users that brings together the most appropriate individuals to participate in an on-line meeting or teleconference. A user who is a prospective participant in an on-line meeting or teleconference clicks on a hyperlink contained in a document to access a query form. Next, the user enters personal identifying information on the query form. Information relating to that user can also be included in parameters associated with the hyperlink. Next, the user clicks on a button associated with the query form to pass the personal identifying information to a real-time messaging server, which generates a request for an on-line meeting or teleconference, and provides the meeting request to one or more other specified users. Because the meeting request includes some or all of the information entered on the query form and included in the hyperlink parameters, the specified users can decide whether or not to join an on-line meeting or teleconference with the prospective participant based at least in part on the information provided.

### CROSS REFERENCE TO RELATED APPLICATIONS

This application claims benefit of U.S. Provisional Patent Application No. 60/796,366 filed May 1, 2006 entitled WEB-BASED SYSTEM AND METHOD OF ESTABLISHING AN ON-LINE MEETING OR TELECONFERENCE.

### STATEMENT REGARDING FEDERALLY SPONSORED RESEARCH OR DEVELOPMENT

Not applicable

### BACKGROUND OF THE INVENTION

The present invention relates generally to real-time communications systems, and more specifically to a real-time communications system for initiating a real-time communications session involving a plurality of users, in which one or more specified parameters or other information can be associated with a user's request for an on-line meeting or teleconference. The real-time communications system can determine one or more appropriate recipients of the user's meeting request, and/or perform one or more predetermined actions, based at least in part upon the specified parameters or other information associated with the user's request.

Real-time communications systems are known that can be employed to convene on-line meetings, teleconferences, or other forms of on-line communications involving multiple users in real-time. For example, U.S. Pat. No. 7,149,288 issued Dec. 12, 2006 entitled RULES BASED REAL-TIME COMMUNICATION SYSTEM assigned to the same assignee of the present invention (“the '288 patent”) discloses a real-time messaging system that includes a plurality of client or user computers communicably coupleable to a real-time messaging server computer via a communications network such as the Internet. The real-time messaging system disclosed in the '288 patent maintains and stores an availability status in association with each system user. The availability status of a user corresponds to what is commonly referred to as the on-line presence of that user. The real-time messaging server applies a set of rules and/or user attributes to the availability statuses of the respective users to find appropriate users and/or user groups, and to invite them to join an on-line meeting or teleconference.

As disclosed in the '288 patent, to initiate an on-line meeting or teleconference, a user (the “requester”) generates a request to convene an on-line meeting by entering information into the real-time messaging system via a graphical user interface (GUI) provided on a client computer. For example, the requester of the on-line meeting may enter a list of desired participants for the on-line meeting. It is noted that each meeting participant corresponds to a user of a client computer coupled to the network. The requester may also enter a number of attributes associated with the meeting request (e.g., the meeting topic, location, time, and/or priority) and/or one or more of the meeting participants (e.g., the function or role of a participant, and/or an indication of whether or not the presence of a particular participant is necessary for the on-line meeting to take place). Next, the system identifies the initial members of a participant group, and determines whether each member of the participant group is available to participate in the on-line meeting. Such availability of the participant group members can be determined based upon user-defined availability filtering, and/or the attributes associated with the meeting request, e.g., which user requested the on-line meeting, the meeting topic, and/or whether or not a particular user is a necessary participant in the on-line meeting. In the event one or more members of the participant group are currently unavailable, the real-time messaging system can determine whether or not there are any acceptable stand-ins for the unavailable group members. If there is an acceptable stand-in for an unavailable group member, then the system determines whether that stand-in is available to participate in the on-line meeting. In the event the stand-in is available, the system determines whether or not that user agrees to be a stand-in for the unavailable group member. The system then substitutes all acceptable, available, and agreeable stand-ins in place of the unavailable members of the participant group. Accordingly, based upon whether or not there is a sufficient number of members of the participant group available, and whether or not all members of the participant group deemed necessary are available, the real-time messaging system convenes the on-line meeting among the respective participants.

Another real-time communications system for initiating an on-line meeting or teleconference involving multiple users in real-time is disclosed in U.S. patent application Ser. No. 11/293,035 filed Dec. 2, 2005 entitled SYSTEM AND METHOD OF INITIATING AN ON-LINE MEETING OR TELECONFERENCE VIA A WEB PAGE LINK OR A THIRD PARTY APPLICATION assigned to the same assignee of the present invention (“the '035 application”). The '035 application discloses a real-time messaging system that allows each user of the system to indicate his or her on-line presence via a hyperlink embedded in and displayable on one or more web pages, e-mail messages, or other hyperlink-supporting documents. The hyperlink has an associated area defined by an icon and/or an alphanumeric string, which has an associated uniform resource locator (URL) that points to a document (e.g., a web page) configured to initiate an on-line meeting or teleconference.

As disclosed in the '035 application, a requester of an on-line meeting generates a request to initiate the meeting with one or more other users (the “recipients” of the request) by accessing, via his or her client computer, a first web page upon which an icon is displayed indicating the on-line presence of the respective recipient. Next, the requester of the on-line meeting clicks on the icon, which has an associated URL that points to a second web page containing a form that prompts the requester to provide information based upon whether or not he or she is a subscriber or a registered user of the system. If the requester is a subscriber of the real-time messaging system, then the form prompts the requester to enter a username and a user password to allow the system to authenticate him or her, and, in the event the requester is authenticated, to prompt him or her to enter a topic of the desired on-line meeting. If the requester is not a subscriber of the system, then the form prompts the requester to enter his or her name and e-mail address, and the topic of the desired on-line meeting. After entering the required information into the real-time messaging system via the displayed form, the requester waits for a period of time while the system performs one of two sequences of process steps based upon whether the recipient is an individual or represents a “lifeline”, which is defined herein as a list of users having a name and one or more ordering attributes associated therewith.

As further disclosed in the '035 application, in the event the recipient is an individual and the on-line presence of the recipient indicates that he or she is currently on-line or “available”, the real-time messaging system performs a first sequence of process steps including causing a first window (known as a “toast”) to open or “pop-up” on the display of the recipient's computer, announcing the requester's invitation to join the on-line meeting. If the recipient clicks on the toast, then the system causes a first dialog box to appear on the recipient's computer display indicating the requester's name and the topic of the desired on-line meeting. The first dialog box includes at least one button that may be clicked on by the recipient to accept or reject the requester's invitation to join the on-line meeting. If the requester is not a subscriber of the real-time messaging system, then the first dialog box provides a message warning the recipient that the requester is not an authenticated user of the system. In the event the recipient represents a lifeline, the real-time messaging system performs a second sequence of process steps, causing a second toast to pop-up on the computer display of a specified one of the users listed in the lifeline. If the specified user listed in the lifeline clicks on the toast, then the system causes a second dialog box to appear on that user's computer display indicating the requester's name and the topic of the desired on-line meeting. If the recipient does not accept the requester's invitation to join the on-line meeting within a predetermined time period, then a message is provided on the requester's computer display indicating that the recipient is currently off-line, busy, does not want to be disturbed, or is otherwise “unavailable”.

If the recipient accepts the requester's invitation to join the on-line meeting, then a meeting window opens on the recipient's computer display, after which a meeting window similarly opens on the requester's computer display, thereby convening the on-line meeting of the requester and the recipient over the network. For example, messages in the form of text messages, audible speech, and/or visual images including video images of the requester and/or the recipient may be exchanged between the respective users of the real-time messaging system via user interaction with the respective meeting windows. Accordingly, like the real-time messaging system disclosed in the '288 patent, the real-time messaging system of the '035 application convenes an on-line meeting between the requester and the recipient based upon whether or not the recipient is available, and whether or not he or she accepts the requester's invitation to join the on-line meeting.

One drawback of the real-time messaging systems disclosed in the '288 patent and the '035 application is that a user's request for an on-line meeting or teleconference can be received and accepted by one or more other system users who are not the most appropriate individuals to participate in the on-line meeting or teleconference. This can be problematic when an on-line meeting or teleconference is requested for the purpose of purchasing or selling a product and/or service over the Internet. For example, the requester of an on-line meeting may be a prospective customer, and the recipient of the request may be one or more sales representatives of a merchant or business. If the prospective customer's request for an on-line meeting is not received and accepted by the most appropriate sales representative, then that customer may quickly become frustrated with the sales experience, and may abandon the on-line meeting well before reaching the point of making a purchase. In addition, in the context of purchasing or selling products and/or services over the Internet, the above- described real-time messaging systems are not easily configurable to provide suitable sales presentations to prospective customers seeking to purchase particular products or services.

It would therefore be desirable to have a real-time communications system for initiating a real-time communications session involving a plurality of users that avoids the drawbacks of the above-described real-time messaging systems.

### BRIEF SUMMARY OF THE INVENTION

In accordance with the present invention, a real-time communications system for initiating a real-time communications session involving a plurality of users is provided that brings together the most appropriate individuals to participate in an on-line meeting or teleconference, while providing the capability of presenting suitable presentations to selected participants of the on-line meeting or teleconference. The presently disclosed system can be used to facilitate product sales and/or service over the Internet by enabling a prospective customer seeking to purchase a product or service to make contact with the most appropriate sales representative for that particular product or service, and by providing the sales representative with the capability of presenting a sales presentation suitable for that particular customer.

In one embodiment, the real-time communications system includes a plurality of client computers, at least one real-time messaging server, at least one gateway server, a presence server, a database server, and at least one communications network such as the Internet. For example, the plurality of user computers may include a PC client, a Flash client, a mobile client, a browser client, and/or a web services client. The real-time messaging server includes a plurality of software components such as a rules engine with a plurality of functional units, and a plurality of object definitions associated with the functional units of the rules engine. The presently disclosed system is operative to allow the plurality of client computers to communicate with the real-time messaging server over the Internet. Such communications among the client computers and the real-time messaging server are performed through a client abstraction layer including a Macromedia Flash™ Media Server and a web server. For example, the PC client, the Flash client, and the mobile client may communicate with the real-time messaging server through the Flash Media Server, and the browser client and the web services client may communicate with the real-time messaging server through the web server. In the disclosed embodiment, on-line presence and meeting request messages originating from the PC, Flash, and mobile clients are passed from the Flash Media Server directly to the rules engine of the real-time messaging server, while on-line presence and meeting request messages originating from the browser and web services clients are passed from the web server to the rules engine via the gateway server. On-line presence data contained in the on-line presence messages are stored within the presence server, and data, parameters, and/or other information relating to the rules, the users, user stand-ins, the user groups, user preferences and group definitions, and internal and/or external data sources are stored in the database server. The data, parameters, and/or other information stored within the database server are accessible by the real-time communications system through a data source layer that provides data mining capabilities.

In one mode of operation, the presently disclosed real-time communications system can be used to facilitate the sale of a product and/or service over the Internet by enabling a prospective customer operating a client computer (the “customer computer”) to make contact with the most appropriate sales representative for that product or service operating another client computer (the “salesperson computer”). In the event the customer is interested in purchasing a product and/or service from a merchant or business over the Internet, the customer uses his or her computer to access that merchant or business's web page, which includes a customer query form. Next, via the keyboard and/or mouse of the customer computer, the customer enters specified personal identifying information on the query form such as his or her name, demographic information, or any other suitable information that a sales representative of the merchant or business might use to sell a product or service to that customer. In one embodiment, the customer can click on a hyperlink contained in a document such as an e-mail message or a web page to access the merchant's web page including the query form. After entering his or her personal identifying information on the query form, the customer clicks on a button located within the query form or at some other location within the merchant's web page to pass the specified information entered on the query form to the real-time messaging server over the Internet.

In response to receiving the prospective customer's information, the real-time messaging server generates and submits a request for an on-line meeting or teleconference with a sales representative of the merchant or business. The customer then waits for a period of time while the server determines whether or not a sales representative is currently on-line or “available”. In the event a sales representative is currently available, the real-time messaging server causes a specialized window (known as a “toast”) to open or “pop-up” on the display of that salesperson's computer, announcing the customer's request for an on-line meeting or teleconference. The real-time messaging server is operative to perform at least one predetermined operation after the sales representative clicks on the toast displayed on his or her computer. For example, the real-time messaging server can cause a dialog box to appear on the display of the salesperson computer indicating some or all of the customer's information entered on the query form. Further, the dialog box can include at least one button that the sales representative can click on to accept or reject the customer's request for an on-line meeting or teleconference. Because the real-time messaging server provides an indication of at least some of the customer's information to the sales representative on his or her computer display, the sales representative can decide whether or not to accept the customer's request for an on-line meeting or teleconference based at least in part upon the customer's information.

In the presently disclosed embodiment, the sales representative can be represented by a “lifeline”, which is defined herein as a list of individuals that has a name and one or more ordering attributes associated therewith. For example, a lifeline corresponding to a list of sales representatives within a technical sales support group for a given product or service may be given the name “Product-A Tech Sales”, and may therefore be referred to as the “Product-A Tech Sales Lifeline”. In the event the sales representative is represented by a lifeline, the real-time messaging server can cause a toast to pop-up on the display of at least one computer of at least one specified sales representative listed in the lifeline, announcing the prospective customer's request for an on-line meeting or teleconference. If the specified sales representative clicks on the toast, then the real-time messaging server causes a dialog box to appear on that salesperson's computer display, indicating the customer's request for an on-line meeting or teleconference and some or all of the customer's information entered on the query form. If the sales representative does not accept the customer's request for an on-line meeting or teleconference within a predetermined time period, then the real-time messaging server causes a toast to pop-up on the display of at least one computer of at least one of the other sales representatives listed in the lifeline. If none of the other sales representatives listed in the lifeline accepts the customer's request within a predetermined time period, then a message is provided on the customer's computer display, indicating that the sales lifeline is currently “unavailable”.

Next, the real-time messaging server causes a dialog box to appear on the display of the prospective customer computer, providing the customer with a choice of trying again to initiate an on-line meeting or teleconference with a sales representative of the merchant or business, waiting in a queue until a sales representative is available to participant in an on-line meeting or teleconference, or being directed to specified web page to receive more information regarding the desired product or service. If, after viewing the customer's information contained in the dialog box displayed on his or her computer, the sales representative accepts the customer's request for an on-line meeting or teleconference, then specialized meeting windows open on the respective displays of the salesperson and customer computers. By interacting with the meeting windows displayed on their respective computer displays, the customer and the sales representative can exchange, in real-time, various messages in the form of text, images, audible speech, audio, and/or video, including video images of the customer and/or the sales representative.

In this way, based at least in part upon the customer's information provided to the sales representative(s), the presently disclosed real-time communications system can convene an on-line meeting or teleconference involving the customer and the most appropriate sales representative for the desired product or service. In addition, based at least in part upon the customer's information, the on-line meeting or teleconference can be convened with a suitable sales presentation already loaded onto the system.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a block diagram of a real-time communications system according to the present invention, in which a number of client systems are interconnected with a real-time messaging server via a communications network;

FIG. 2 is a block diagram of the real-time communications server of FIG. 1;

FIG. 3 is a functional block diagram of the real-time communications system of FIG. 1;

FIGS. 4a-4d is a flow diagram of a method of convening an on-line meeting or teleconference using the real-time communications system of FIG. 1; and

FIGS. 5a-5i are exemplary representations of computer display screens and windows displayed on client systems while initiating an on-line meeting involving multiple system users using the real-time communications system of FIG. 1.

### DETAILED DESCRIPTION OF THE INVENTION

The entire disclosure of U.S. Provisional Patent Application No. 60/796,366 filed May 1, 2006 entitled WEB-BASED SYSTEM AND METHOD OF ESTABLISHING AN ON-LINE MEETING OR TELECONFERENCE is incorporated herein by reference.

A real-time communications system for initiating a real-time communications session involving a plurality of users is disclosed that brings together the most appropriate individuals to participate in an on-line meeting or teleconference, while providing the capability of presenting suitable presentations to selected participants of the on-line meeting or teleconference. The presently disclosed real-time communications system can be used to facilitate product sales and/or service over the Internet by enabling a prospective customer seeking to purchase a product or service to make contact with the most appropriate sales representative for that particular product or service, and by providing the sales representative with the capability of presenting a sales presentation suitable for that particular customer.

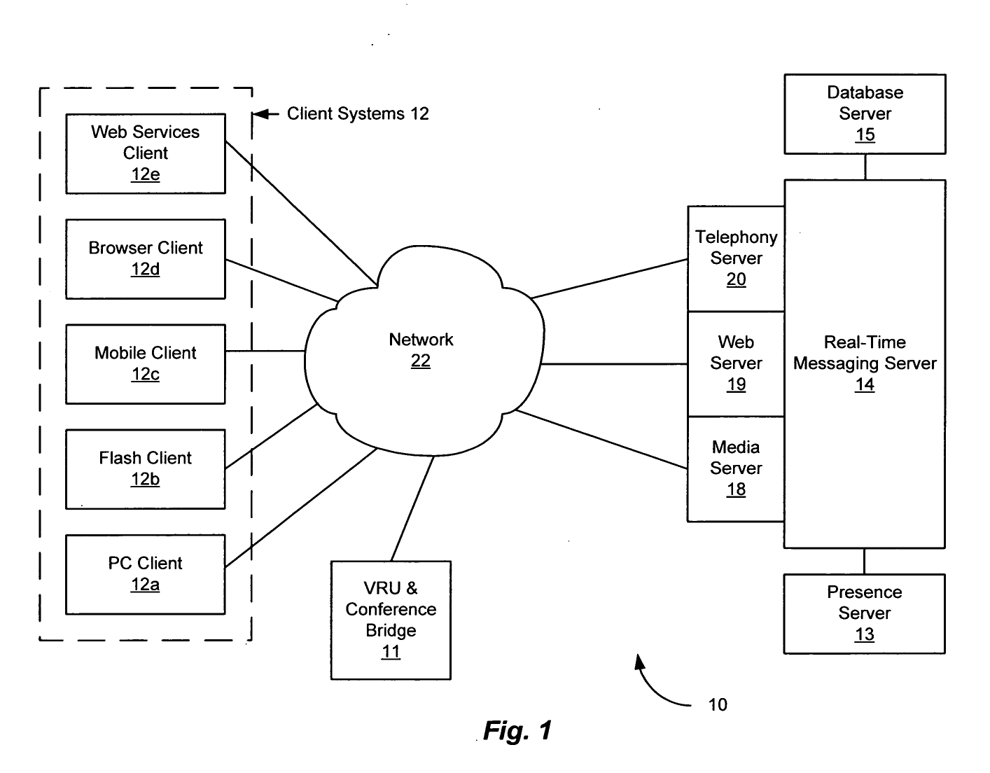

FIG. 1 depicts an illustrative embodiment of a real-time communications system 10, in accordance with the present invention. As shown in FIG. 1, the real-time communications system 10 includes a plurality of user or client systems 12, a voice response unit (VRU) and conference bridge 11, at least one real-time messaging server 14, a media server 18, a web server 19, a telephony server 20, a presence server 13, a database server 15, and a communications network 22. For example, the communications network 22 can include the Internet or any other suitable data or telecommunications network. Further, the plurality of client systems 12 can include a PC client computer 12a, a device 12b running the Macromedia Flash Player™ application (“Flash client”), a mobile client computer 12c, a browser client computer 12d, and a web services client computer 12e, each of which is communicably coupleable to the communications network 22. The media server 18, the web server 19, and the telephony server 20 are also communicably coupleable to the network 22. In an alternative embodiment, the plurality of user systems 12 can include at least one telephone, and the communications network 22 can include the public switched telephone network (PSTN).

In the presently disclosed embodiment, the PC client 12a, the Flash client 12b, and the mobile client 12c are operative to communicate with the real-time messaging server 14 over the network 22 through the media server 18, which can be any suitable type of media server such as the Flash Media Server sold by Adobe Systems Incorporated, San Jose, Calif., U.S.A. Further, the browser client 12d and the web services client 12e are operative to communicate with the real-time messaging server 14 over the network 22 through the web server 19, which can be any suitable type of web server such as the Internet information server (IIS) sold by Microsoft Corporation, Redmond, Washington, U.S.A., the WEBSPHERE™ server sold by International Business Machines (IBM) Corporation, Armonk, N.Y. U.S.A., or the WEBLOGIC™ server sold by BEA Systems, Inc., San Jose, California, U.S.A. Moreover, the VRU and conference bridge 11 is operative to communicate with the real-time messaging server 14 over the network 22 through the telephony server 20.

It is noted that the client systems 12a-12e, the VRU and conference bridge 11, and the server systems 14 and 18-20 can be embodied as one system or as separate computer systems, each including one or more processors, program code memory, one or more secondary program code storage devices, a number of input/output interface devices, and operating system and application program software, as configured for a given operational environment. For example, in one embodiment, the real-time communications system 10 can include the browser client 12d and the web server 19 communicating with one another using the hyper-text transport protocol (HTTP). In an alternative embodiment, the system 10 can include the Flash client 12b and the media server 18 communicating with one another using the real-time messaging protocol (RTMP). The Flash application software can run stand-alone on the Flash client 12b or under the control of a web browser. It is also noted that the system 10 can operate in Flash, Java, Javascript, or any other suitable programming environment. In the presently disclosed embodiment, the media server 18 and the web server 19 are operative to execute web server software, and can incorporate an HTTP server for managing web page requests received over the network 22, and for delivering hyper-text mark-up language (HTML) documents in response to the web page requests. It is further noted that the client systems 12 are not required to execute specialized, dedicated client-side application software to access the features provided by the system 10. Instead, messages and content used to access the system features can be loaded and processed within the client systems, as needed, using known client-side application software, such as Flash, Java, or Javascript software operative to provide text, video, and/or other content in an interactive graphics format through web content downloaded to a web browser executing on the client system.

The real-time communications system 10 provides real-time messaging functionality among the users of the client systems 12 and optionally the users of the VRU and conference bridge 11 based upon a plurality of rules and a rules engine implemented within the real-time messaging server 14. The real-time communications system 10 is operative to provide such real-time messaging in response to a number of monitored conditions, such as the availability status of the users and the detection of one or more predetermined events. The real-time communications system 10 also provides a number of features relating to user groups. For example, the disclosed system permits group definitions to be shared among multiple users. Further, temporary membership in a particular group can be enabled to grant temporary access to data and/or specific functions associated with that group. Moreover, to determine the most appropriate members for a particular group or the most appropriate stand-in for a particular user, the disclosed system can provide data mining capabilities for relevant skills assessment. Such features of the disclosed system relating to real-time messaging, stand-ins, and user groups are further described in U.S. Pat. No. 7,149,288 filed Dec. 9, 2003 entitled RULES BASED REAL-TIME COMMUNICATION SYSTEM (“the '288 patent”), the entire disclosure of which is incorporated herein by reference.

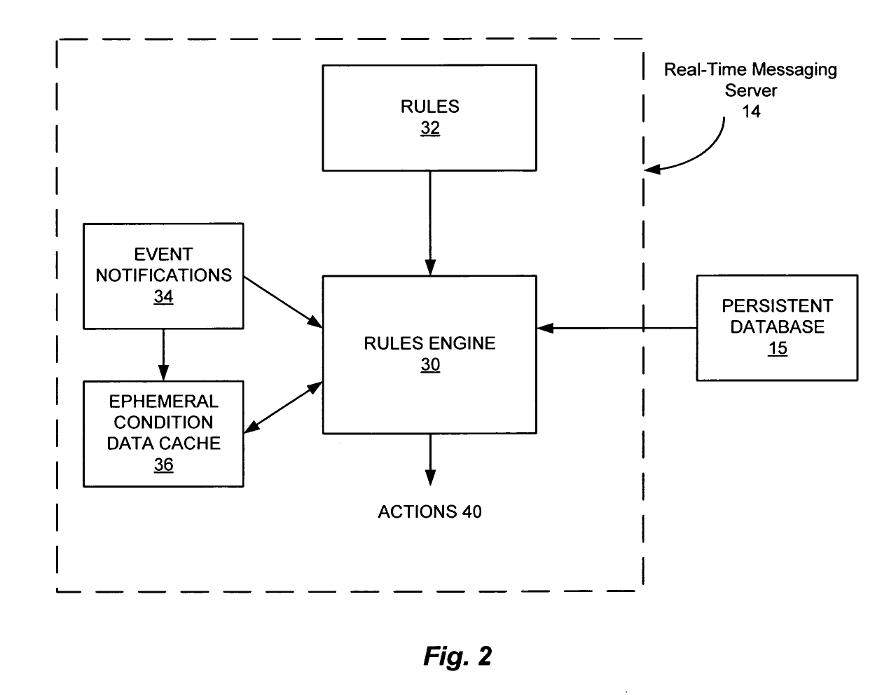

FIG. 2 depicts an illustrative software configuration of the real-time messaging server 14 (see FIG. 1). In the illustrated embodiment, the software configuration includes a rules engine 30 operative to process a plurality of rule definitions 32. In the illustrated embodiment, the rules engine 30 is responsive to event notifications 34 and the contents of an ephemeral condition data cache 36. The rules engine 30 is further responsive to the contents of the persistent database 15, which may, for example, be stored on a separate database server system (see FIG. 1). In an alternative embodiment, the rules 32 can be provided within the rules engine 30 itself. The ephemeral condition data cache 36 includes presence indications for multiple users of the disclosed system. Such presence indications reflect the instantaneous on-line availability of the system users. It is noted that the ephemeral condition data cache 36 can be implemented on a separate data storage server system such as the presence server 13 (see FIG. 1). The persistent database 15 is operative to store configuration data reflecting user preferences and user group definitions. For example, such configuration data can include data relating to stand-in definitions, availability filters, and/or contact lists of the various system users. The rules 32 define a plurality of actions 40 that are performed in response to the event notifications 34, information provided by the ephemeral condition data cache 36, and/or information provided by the persistent database 15. The rules 32 are processed by the rules engine 30, which can be implemented using any suitable programming language. For example, the actions 40 performed by the rules engine 30 can include actions facilitating real-time group activities such as convening an on-line meeting or teleconference, sending e-mail or instant messages to one or more system users, and/or routing a document. The various actions 40 can range from simple to complex actions, and can include multi-stage actions that are performed in several distinct steps, depending at least in part upon the receipt of separate event notifications and the state of conditions stored in the ephemeral condition data cache 36 over time. The software components of the real-time messaging server 14 are further described in the above-referenced '288 patent.

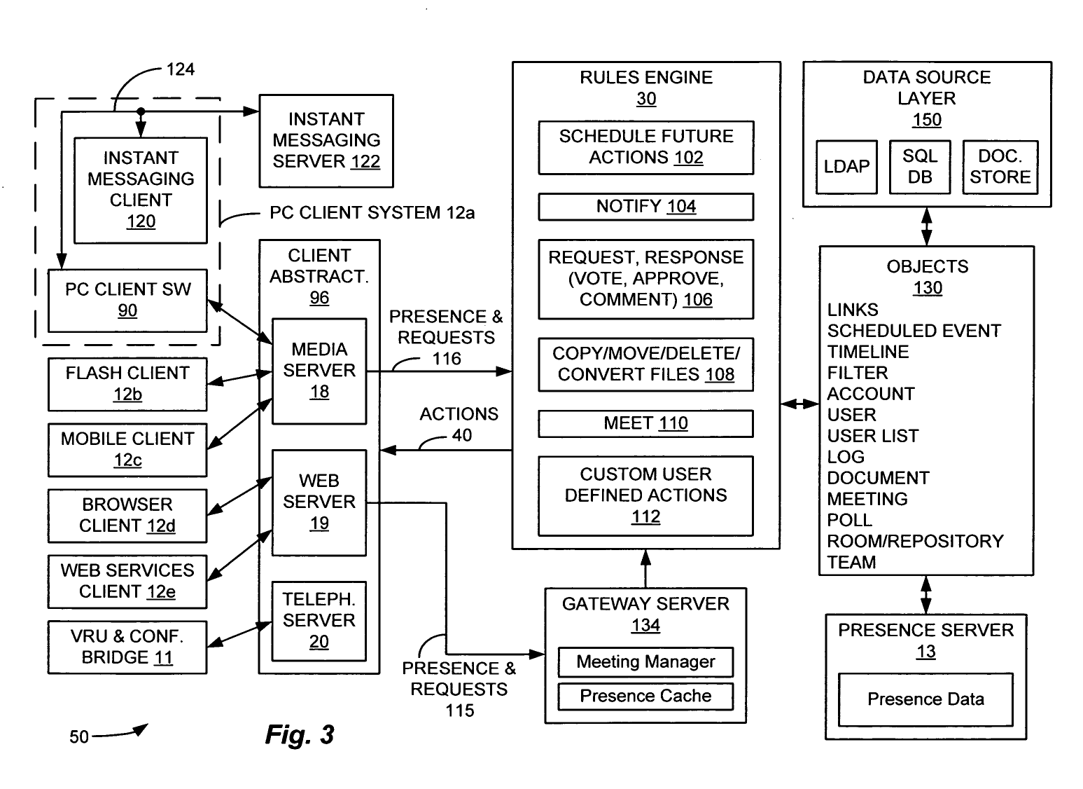

FIG. 3 depicts an illustrative embodiment of an architecture 50 of the presently disclosed real-time communications system, including a representation of the rules engine 30 (see FIG. 2). In the illustrated embodiment, the rules engine 30 includes a plurality of functional units, each of which is operative to perform one or more real-time communications activities. In one embodiment, the plurality of functional units includes a schedule future actions unit 102 for scheduling actions to be performed at later points in time, a notify unit 104 for performing notification actions, a request, response (vote, approve, comment) unit 106 supporting certain types of request and response actions relating to voting, approval, and commenting, a copy/move/delete/convert files unit 108 supporting file operations performed by the rules engine 30, a meet unit 110 for convening meetings, and a custom user defined actions unit 112. It should be noted that the specific functional units included in the rules engine 30 of FIG. 3 are described herein for purposes of illustration only, and that any suitable functional units can be included within the rules engine 30 for a given embodiment. The various functional units included in the rules engine 30 define the processing performed by the rules engine 30, and reflect the specific set of rules loaded into the rules engine 30.

As shown in FIG. 3, the rules engine 30 interfaces to a data source layer 150 through a number of object definitions 130, which provide a predetermined interface to data sources such as an SQL database and a document storage database. It is noted that the data sources accessed via the data source layer 150 can be configured to store event data, ephemeral data, and/or persistent data. As described above, the disclosed system can provide data mining capabilities. To that end, the data source layer 150 can be configured to implement any suitable directory access protocol such as the lightweight directory access protocol (LDAP), which is a known Internet protocol that e-mail and other software programs can employ to look up information stored on a server. It is noted that, in addition to relational databases provided within the system for storing its own information, the data source layer 150 can also include external sources of data such as a corporate directory.

Within the architecture 50 of FIG. 3, communications among the client systems 12a-12e, the VRU and conference bridge 11, and the rules engine 30 are performed through a client abstraction layer 96, which includes the media server 18, the web server 19, and the telephony server 20 (see FIG. 1). As shown in FIG. 3, the rules engine 30 is operative to receive and process presence information and meeting request messages 115-116. The presence information and meeting requests 116 originate from the PC client 12a, the Flash client 12b, and the mobile client 12c, and are passed directly to the rules engine 30 by the media server 18. Further, the presence information and meeting requests 115 originate from the browser client 12d and the web services client 12e, and are passed to the rules engine 30 via a gateway server 134. The presence data 115-116 provided to the rules engine 30 via the client abstraction 96 are indicative of the on-line status of one or more users operating on one or more of the client systems 12a-12e. Moreover, the meeting requests 115-116 provided to the rules engine 30 via the client abstraction 96 can include requests for real-time group activities such as requests to convene on-line meetings or teleconferences and/or requests to send messages between system users. After processing the presence information and requests 115-116, the rules engine 30 issues the appropriate actions 40 back to the client systems 12a-12e via the client abstraction 96. For example, such actions can include real-time group actions relating to the convening of an on-line meeting or teleconference and/or the passing of messages between the system users.

In the presently disclosed embodiment, the PC client system 12a incorporates client software 90 and a third party instant messaging client 120. For example, the third party instant messaging client 120 can comprise any suitable instant messaging client software such as AIM-AOL Instant Messenger, Yahoo! Messenger, Windows Live Messenger, Windows Messenger, or IBM Lotus Sametime. These and various other instant messaging systems are considered external to the disclosed real-time communications system. The instant messaging client 120 communicates with an instant messaging server 122 over a communications network 124. In one embodiment, during operation of the disclosed system, the client software 90 intercepts communications between the instant messaging client 120 and the associated instant messaging server 122 to determine the on-line presence status of one or more users of the instant messaging client 120. The mechanism by which the real-time communications system 10 (see FIG. 1) operates to determine user presence information from one or more separate instant messaging software systems is further described in the above-referenced '288 patent.

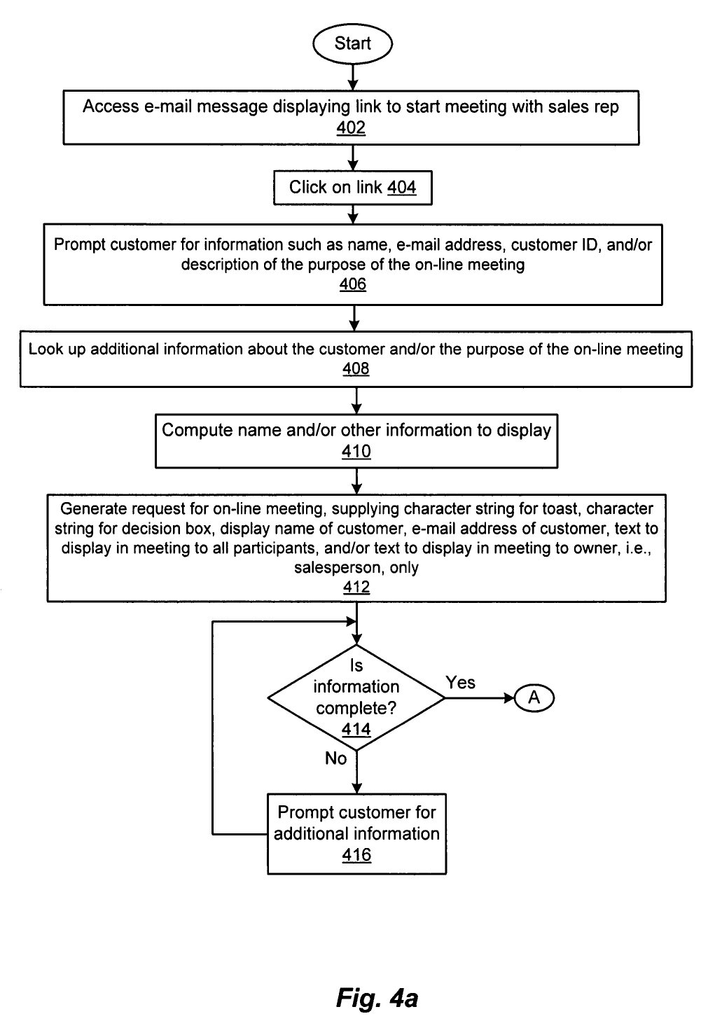

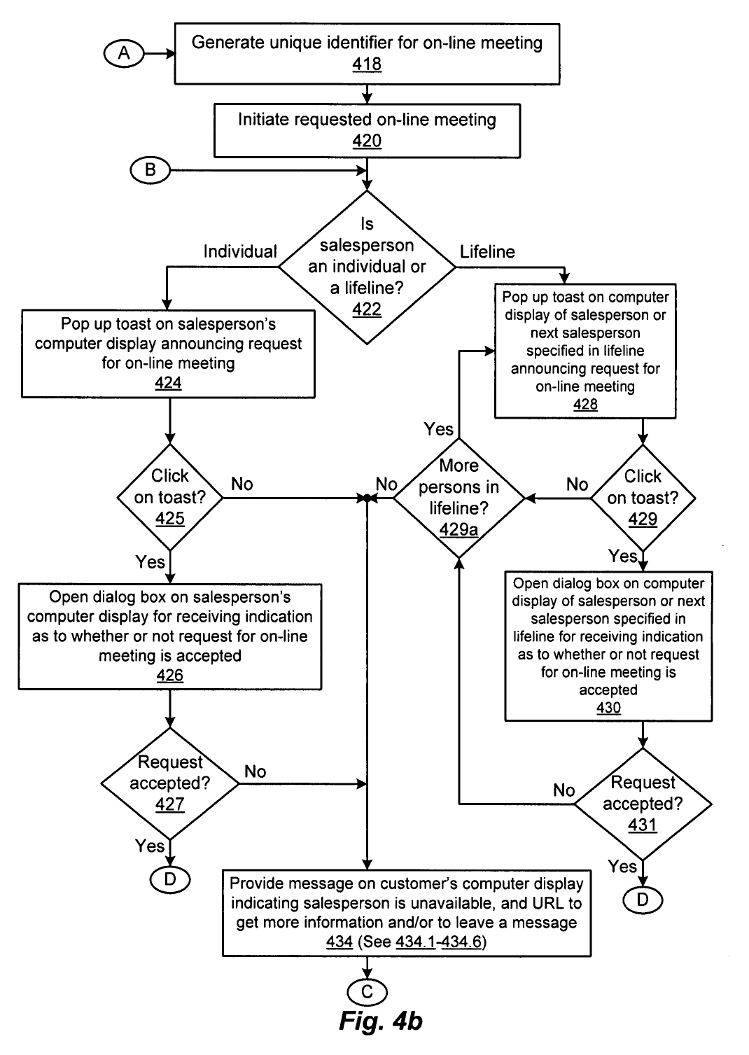

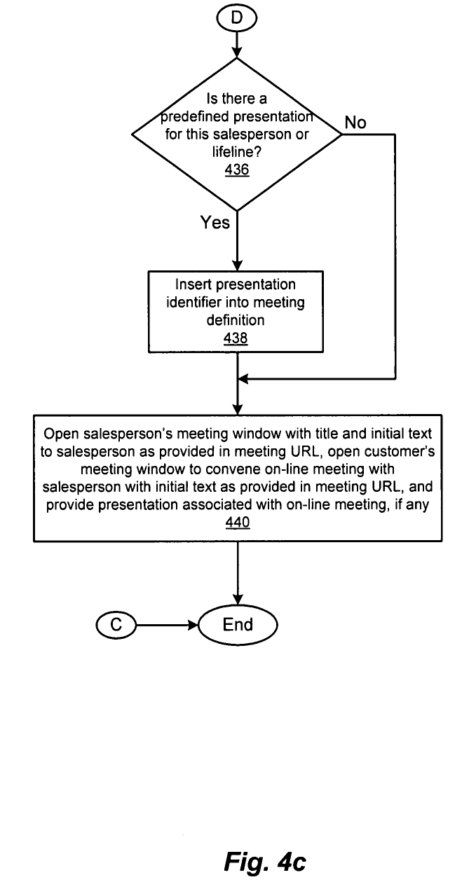

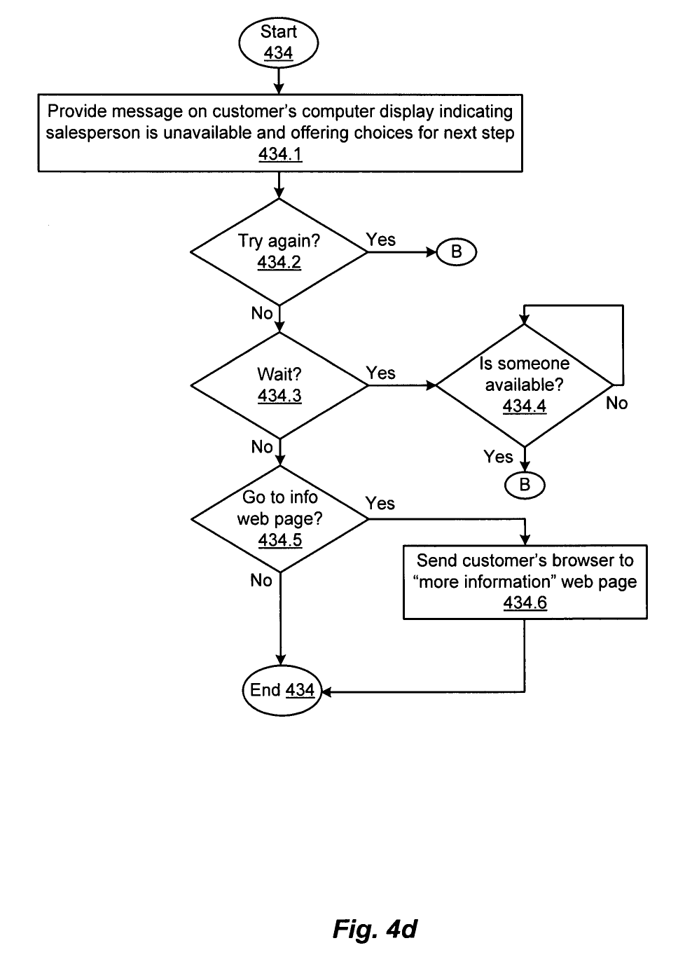

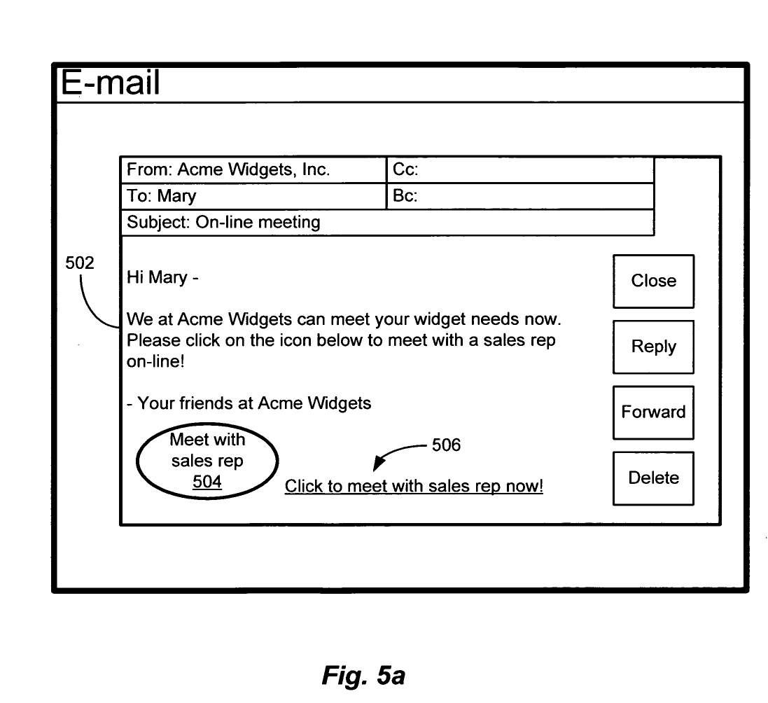

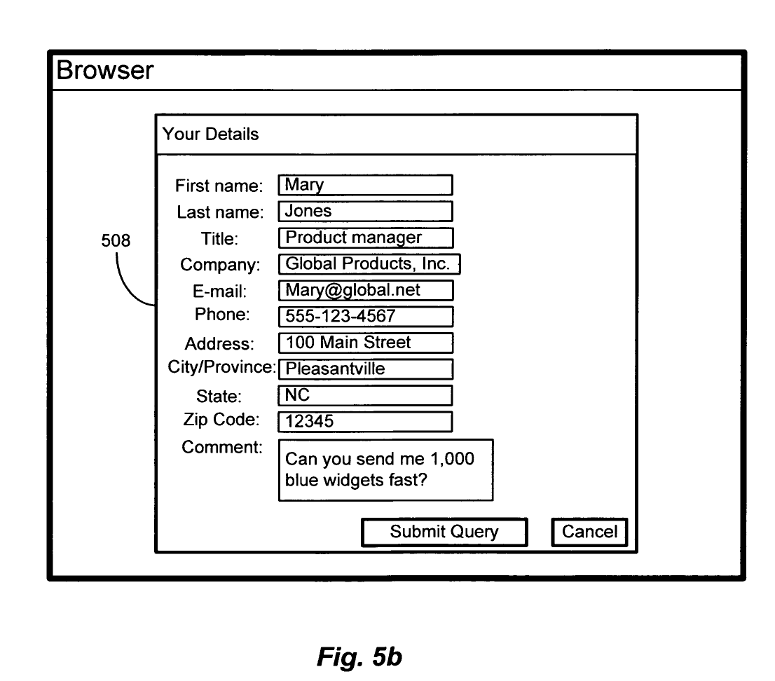

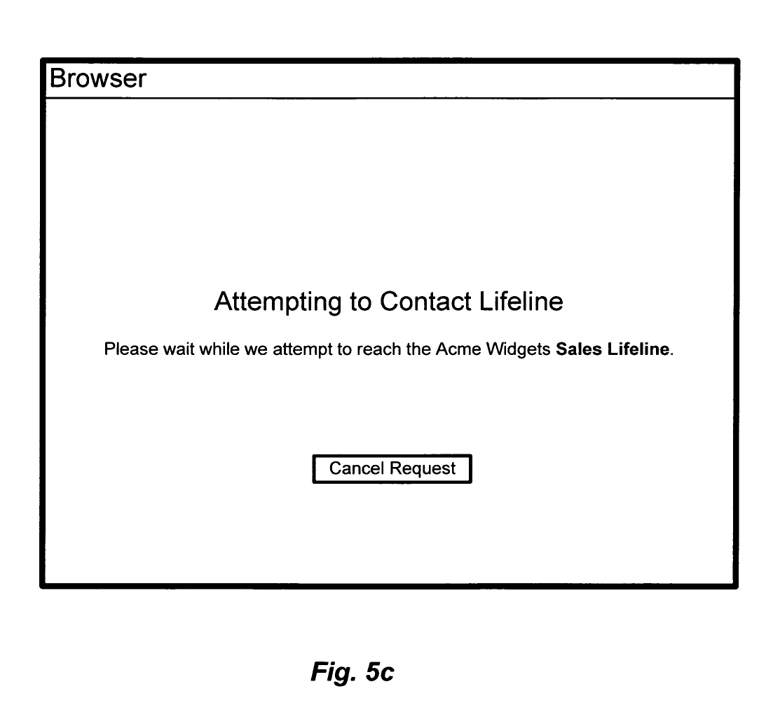

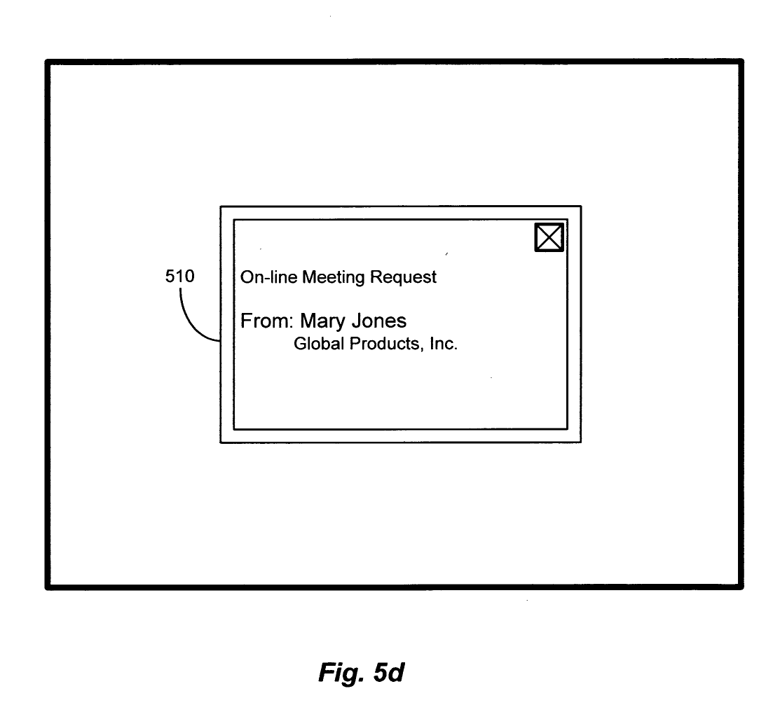

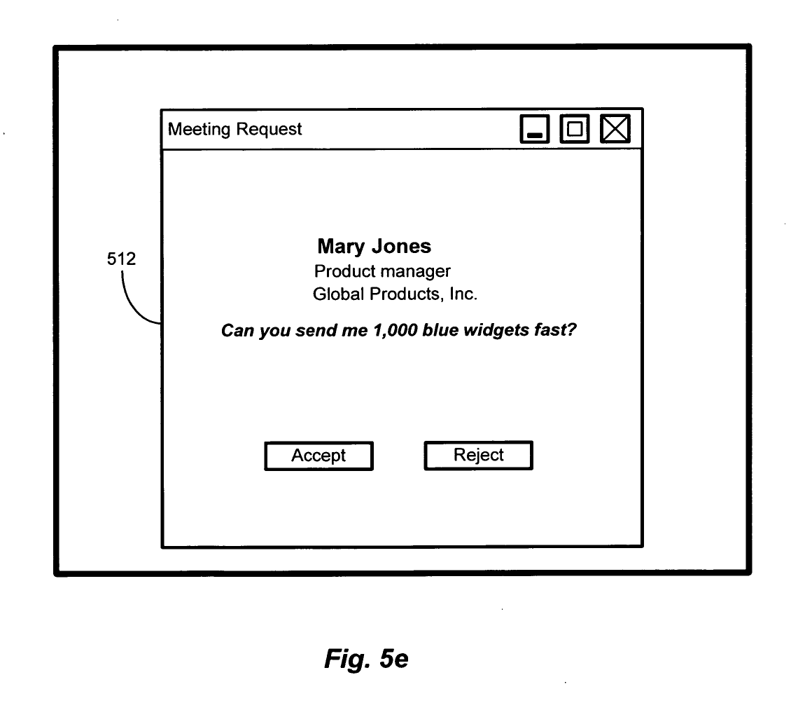

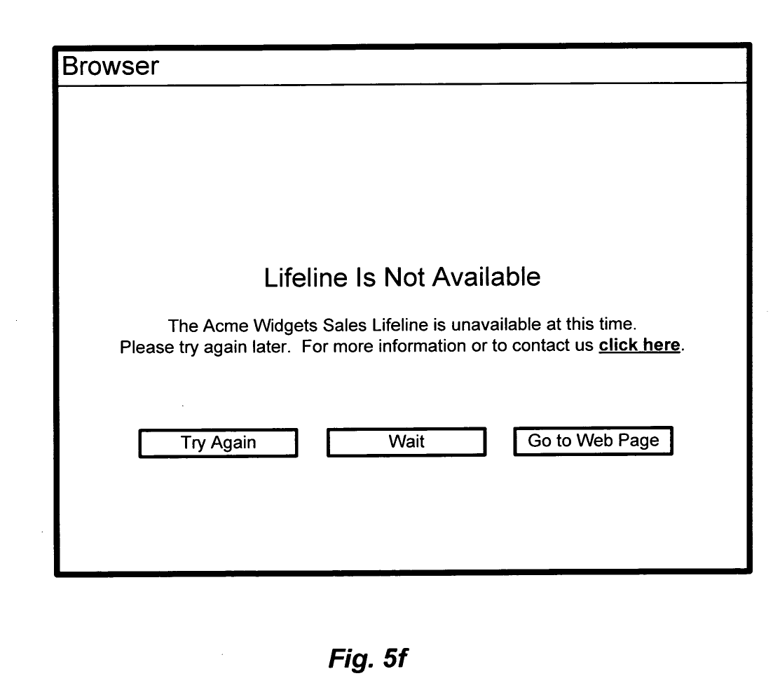

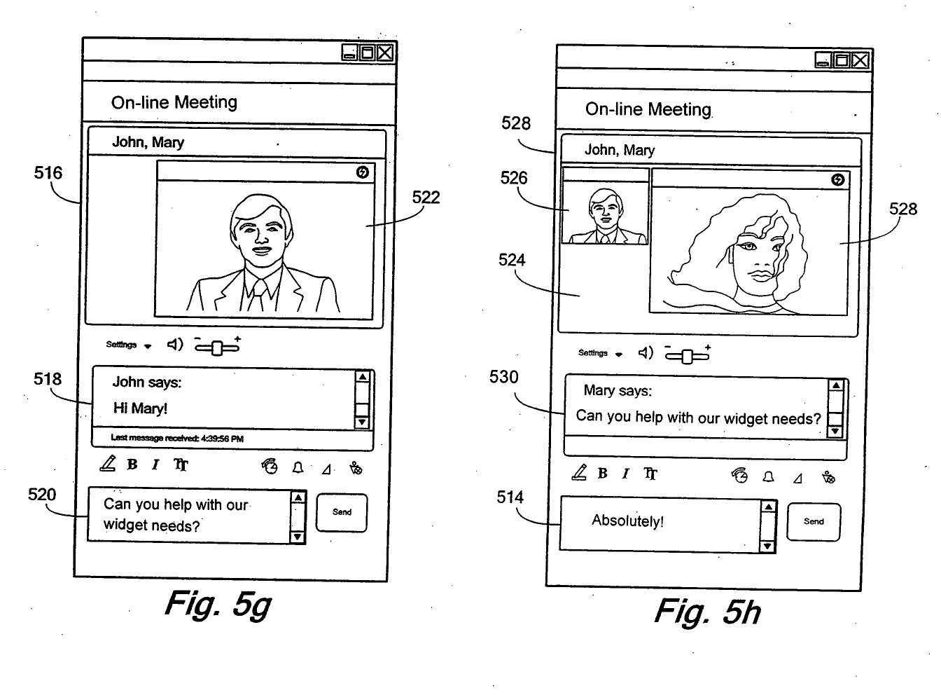

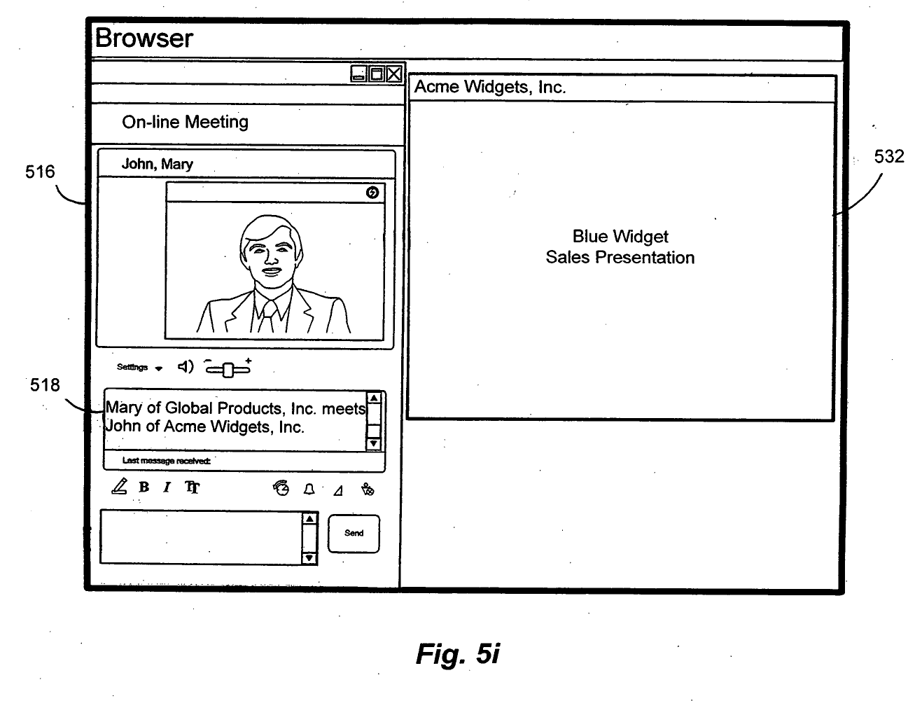

In one mode of operation, the presently disclosed real-time communications system 10 (see FIG. 1) can be used to facilitate the sale of a product and/or service over the Internet 22 by enabling a prospective customer operating a client computer (the “customer computer”) to make contact with the most appropriate sales representative for that particular product or service operating another client computer (the “salesperson computer”). For example, each of the customer and salesperson computers can correspond to one of the client computer systems 12. An illustrative method of operating the real-time communications system 10 to facilitate such a sale of a product and/or service over the Internet is described below with reference to FIGS. 4a-4d and 5a-5i.

In the event the customer is interested in purchasing a product and/or service from a merchant or business over the Internet, the customer uses his or her computer to access that merchant or business's web page, which includes a customer query form. For example, as depicted i( step 402 (see FIG. 4a), the customer (“Mary”) can access an e-mail message 502 (see FIG. 5a) from the merchant (“Acme Widgets, Inc.”) which includes a hyperlink for initiating an on-line meeting with a sales representative. The hyperlink has an associated area that can be defined by a button or icon 504 and/or an alphanumeric string 506, which is hyperlinked to a uniform resource locator (URL) pointing to a document, e.g., a web page configured to initiate the on-line meeting or teleconference. In an alternative embodiment, the icon 504 and/or alphanumeric string 506 can be contained in a web page different from the merchant's web page, or in any other suitable document. For example, the hyperlink and the characteristics of its associated icon or string can be defined by a code fragment (HTML or non-HTML) embedded in or otherwise inserted into (e.g., copied and pasted) the document supporting the hyperlink.

Next, via a keyboard, a mouse, or any other suitable input device of the customer computer, the customer clicks on the icon 504 or the string 506 contained in the e-mail message 502, as depicted in step 404, thereby accessing the merchant's web page containing a customer query form 508 (FIG. 5b). As depicted in step 406, the customer is then prompted to enter personal identifying information on the query form 508, such as his or her name (“Mary Jones”), title (“Product manager”), company (“Global Products, Inc.”), e-mail address (“Mary@global.net”), telephone number (”555-123-4567”), business address (“100 Main Street, Pleasantville, N.C. 12345”), specific comments (“Can you send me 1,000 blue widgets fast?”), and/or any other suitable information that a sales representative of the merchant or business might use to sell a product or service to that customer. In one embodiment, the real-time communications system 10 can also be configured to access additional information about the customer and/or the purpose of the on-line meeting, as depicted in step 408. Next, the system computes a representation of the customer's name and/or other information for subsequent display to a sales representative, as depicted in step 410, and generates a request for the on-line meeting, as depicted in step 412. Specifically, the generation of the request for the on-line meeting can include supplying suitable character strings for subsequent display via a window (known as a “toast”) or a decision/dialog box. Further, the character strings can include the customer's name, the customer's e-mail address, specified text to be displayed to some or all of the meeting participants, and/or specified text to be displayed only to the “owner” of the on-line meeting, i.e., a particular sales representative. As depicted in step 414, a decision is then made as to whether or not the customer information entered on the query form 508 is complete. If not, the customer is prompted to enter additional information, for example, via the highlighting of selected text in the query form 508, as depicted in step 416, and the method branches back to step 414. Otherwise, if the customer information is complete, then the method proceeds to step 418 (see FIG. 4b).

After the customer has completed entering his or her personal identifying information on the query form 508, the customer clicks on a button (“Submit Query”) located within the query form 508, or at some other location within the merchant's web page, to pass the customer information to the real-time messaging server 14 over the communications network 22. In response to receiving the customer information, the real-time messaging server 14 generates a unique identifier for the desired on-line meeting, as depicted in step 418. In one embodiment, the unique identifier for the on-line meeting can be generated using a meeting manager component included within the gateway server 134 (see FIG. 3). It is noted that the process of initiating an on- line meeting or teleconference can take an indefinite amount of time since the process involves sending meeting requests to one or more system users, and waiting for their responses to the requests. Because the real-time communications system 10 generates a unique identifier for each requested on-line meeting, the meeting identifier can be used for optionally canceling the meeting before an intended recipient of the meeting request provides his or her response, thereby avoiding the possibility of waiting an inordinate amount of time for that recipient's response. For example, the customer may click on a button (“Cancel Request”; see FIG. 5c) to cause the system to cancel the meeting request associated with that meeting identifier.

In addition, in response to receiving the customer information, the real-time messaging server 14 initiates the requested on-line meeting with a sales representative of the merchant or business, as depicted in step 420. Specifically, the gateway server 134 provides the meeting identifier to the rules engine 30 to initiate the requested on-line meeting. For example, the requested on-line meeting can be initiated via a JavaScript routine. As the rules engine 30 performs the required actions to initiate the on-line meeting, it can send messages back to the meeting manager component of the gateway server 134, including at least one of a meeting progress report, a meeting URL message, and at least one meeting accept/reject message. In the event any one of these messages indicate that the on-line meeting cannot proceed, e.g., a sales representative rejects the customer's request for an on-line meeting, the rules engine 30 sends a message to the customer informing him or her that the sales representative is unavailable. In one embodiment, the real-time communications system 10 causes the meeting request to be abandoned if the meeting cannot be successfully initiated within a predetermined time period, as determined by an internal or external watchdog timer. In addition, the system monitors the status of the network connections between the real-time messaging server 14 and the customer computer, and causes the meeting request to be abandoned if the customer computer, e.g., the browser client 12d or the web services client 12e, has ceased communicating with the server 14.

As depicted in step 422, a determination is made as to whether a sales representative of the merchant corresponds to an individual or a “lifeline”, which is defined herein as a list of individuals that has a name and one or more ordering attributes associated therewith. For example, a lifeline corresponding to a list of sales representatives within a technical sales support group for a given product or service may be given the name “Product-A Tech Sales”, and may therefore be referred to as the “Product-A Tech Sales Lifeline”. In the event the sales representative corresponds to a lifeline, the customer waits for a period of time while the system attempts to contact one or more of the individuals listed in the lifeline. For example, while attempting to contact one or more individuals in the lifeline, the message “Attempting to Contact Lifeline—Please wait while we attempt to reach the Acme Widgets Sales Lifeline” (see FIG. 5c) can be displayed on the customer computer.

Next, a toast opens or “pops-up” on the display of a salesperson computer belonging to the first individual (sales representative) listed in the lifeline (or a next individual listed in the lifeline), announcing the customer's request for an on-line meeting, as depicted in step 428. For example, a toast 510 (see FIG. 5d) can pop-up on the display of the salesperson computer. As depicted in step 429, a determination is then made as to whether or not that sales representative has clicked on the toast 510. If the sales representative has not clicked on the toast 510 within a predetermined time period (e.g., a sales representative may be currently unavailable), then the method proceeds to step 429a. Otherwise, if the sales representative clicks on the toast 510, then a decision/dialog box 512 (see FIG. 5e) opens on the display of the salesperson computer. The dialog box 512 can contain some or all of the information entered on the query form 508 by the customer. As shown in FIG. 5e, the dialog box 512 contains the customer information “Mary Jones, Product manager, Global Products, Inc.”, and the message “Can you send me 1,000 blue widgets fast?”. The dialog box 512 further contains two buttons (“Accept”, “Reject”), which the sales representative can use either to accept the customer's request for an on-line meeting, or to reject the customer's meeting request. It is noted that the button labels Accept and Reject are described herein for purposes of illustration only, and that any other suitable button labels can be used.

A determination is then made as to whether or not the sales representative has accepted the customer's request for an on-line meeting, as depicted in step 431. If the sales representative accepts the customer's meeting request by, e.g., clicking on the Accept button contained in the dialog box 512, then the method proceeds to step 436 (see FIG. 4c). Because at least some of the information entered on the customer query form 508 is provided to the sales representative within the dialog box 512, the sales representative can decide whether or not to accept the customer's request for an on-line meeting based at least in part upon the customer's information. Otherwise, if the sales representative rejects the customer's meeting request by, e.g., clicking on the Reject button contained in the dialog box 512, then the method branches back to step 429a to determine whether or not there are any more individuals in the lifeline. If so, the method branches back to step 428. Otherwise, a message is displayed on the customer computer indicating, for example, that the “Lifeline Is Not Available—The Acme Widgets Sales Lifeline is unavailable at this time. Please try again later. For more information or to contact us click here (see FIG. 5f)”, thereby providing the customer a hyperlink (“click here”) having an associated URL for use in receiving more information or leaving a message for a sales representative (see step 434).

In one embodiment, a message can be displayed on the customer computer indicating that a sales representative is currently unavailable, and a number of choices can be provided to the customer for the next step in the process, as depicted in step 434.1 (see FIG. 4d). For example, the customer can be provided with the choices of trying to contact the sales lifeline again, waiting in a queue until at least one individual in the lifeline becomes available, or going to a web page to receive more information. Further, the customer may make his or her selection by clicking on one of a number of buttons such as a “Try Again” button, a “Wait” button, or a “Go to Web Page” button (see FIG. 5f). Specifically, a determination is made as to whether or not the customer has clicked on the Try Again button, as depicted in step 434.2. If so, the method branches back to step 422. Otherwise, a determination is made as to whether or not the customer has clicked on the Wait button, as depicted in step 434.3. If so, a determination is made as to whether or not at least one individual in the lifeline is available, as depicted in step 434.4. If an individual in the lifeline becomes available, then the method branches back to step 422. Otherwise, a determination is made as to whether or not the customer has clicked on the Go to Web Page button, as depicted in step 434.5. If so, the browser on the customer computer is directed to a specified web page to obtain more information regarding the merchant and its products, as depicted in step 434.6. After a predetermined time period, if the customer fails to click on any of these buttons, then the method ends.

As shown in FIG. 4b, in the event the sales representative corresponds to an individual, the customer waits for a period of time while the system attempts to contact that individual. Next, a toast pops-up on the display of a salesperson computer belonging to that individual (sales representative), announcing the customer's request for an on-line meeting, as depicted in step 424. For example, a toast can pop-up on the display of the salesperson computer to make the announcement. As depicted in step 425, a determination is then made as to whether or not that sales representative has clicked on the toast. If the sales representative has not clicked on the toast within a predetermined time period (e.g., that sales representative may be currently unavailable), then the method proceeds to step 434. Otherwise, if the sales representative clicks on the toast, then the decision/dialog box 512 (see FIG. 5e) opens on the display of the salesperson computer. A determination is then made as to whether or not the sales representative has accepted the customer's request for an on-line meeting, as depicted in step 427. If the sales representative accepts the customer's meeting request by, e.g., clicking on the Accept button contained in the dialog box 512, then the method proceeds to step 436 (see FIG. 4c). Because at least some of the information entered on the customer query form 508 is provided to the sales representative within the dialog box 512, that sales representative can decide whether or not to accept the customer's request for an on-line meeting based at least in part upon the customer's information. Otherwise, if the sales representative rejects the customer's meeting request by, e.g., clicking on the Reject button contained in the dialog box 512, then the method proceeds to step 434. For example, a message can be displayed on the customer computer indicating that the sales representative is currently unavailable, and providing a hyperlink for use in obtaining more information or to leave a message.

As described above, a sales representative can decide whether or not to accept the customer's request for an on-line meeting based at least in part upon the information contained in the customer query form 508 (see FIG. 5b). In addition, based upon the customer's information entered on the query form 508, an on-line meeting or teleconference can be convened between the customer and a sales representative with a suitable sales presentation already loaded onto the system. As depicted in step 436, in response to a sales representative's acceptance of the customer's request for an on-line meeting, a determination is made as to whether or not a predefined sales presentation exists for that sales representative. For example, the predefined sales presentation can be a Microsoft Office PowerPoint™ presentation, or any other suitable form of presentation that can be presented over a client computer. If so, an identifier for the predefined sales presentation is inserted into the definition of the on-line meeting, as depicted in step 438, and the method proceeds to step 440. If the sales representative does not have a sales presentation to present to the customer during the on-line meeting, then the method proceeds directly from step 436 to step 440.

As depicted in step 440, a meeting window 516 (see FIG. 5g) opens on the customer computer optionally including a title (“On-Line Meeting”; see FIGS. 5g-5i) and initial text (“Mary of Global Products, Inc. meets John of Acme Widgets, Inc.”; see reference numeral 518, FIG. 5i), and a meeting window 528 (see FIG. 5h) opens on the salesperson computer optionally including the title and initial text. In alternative embodiments, the initial text can optionally appear in the meeting window 516, the meeting window 528, and/or in a subsequent transcript of the on-line meeting. A sales presentation 532 (see FIG. 5i) such as a PowerPoint presentation can also be provided for subsequent display alongside the meeting window 516 on the customer computer. For example, the title and initial text can be provided as parameters associated with the meeting URL. The meeting window 516 displayed on the customer computer includes a first region 518 operative to display text messages from John (“Hi Mary!”; see FIG. 5g), and a second region 520 operative to allow Mary to enter and send text messages to John (“Can you help with our widget needs?”; see FIG. 5g). The meeting window 528 displayed on the salesperson computer similarly includes a first region 530 operative to display text messages from Mary (“Can you help with our widget needs?”; see FIG. 5h), and a second region 514 operative to allow John to enter and send text messages to Mary (“Absolutely!”; see FIG. 5h). In one embodiment, the meeting window 516 and/or the meeting window 528 include a third region 522 (see FIG. 5g) configured to display video images of Mary and/or John. As shown in FIG. 5g, the meeting window 516 on the display of the customer computer includes the region 522 (see FIG. 5g) containing a video image of John. In an alternative embodiment, the meeting window 516 and/or the meeting window 528 can include a fourth region 524 (see FIG. 5h) configured to display a video image 526 of John alongside a video image 528 of Mary. In further alternative embodiments, the meeting windows 516, 528 can be configured to allow meeting participants to exchange, in real-time, various messages, data, and/or other information in the form of text, images, audible speech, audio, video, PowerPoint presentations, application sharing, screen and window sharing, whiteboards, file transfers, PSTN conference calls, etc., during an on-line meeting or teleconference. The meeting windows 516, 528 can also be configured to provide stored content such as pre-defined text (e.g., the salesperson computer can display a button that a sales representative can click on to enter a specified phrase or question), pre-recorded video or audio, a pre-loaded PowerPoint presentation, and/or a Flash movie application including, for example, a questionnaire, a survey, a poll, advertising, entertainment, sweepstakes information, search of a knowledge base, and/or a game. After the meeting windows 516, 528 are opened on the customer and salesperson computers, respectively, to convene the on-line meeting between the customer (Mary) and the sales representative (John), the method ends.

Having described the above illustrative embodiments, other alternative embodiments or variations may be made. For example, it was described that if a customer is interested in purchasing a product and/or service from a merchant or business over the Internet, then the customer can use his or her computer to access that merchant or business's web page, which can include a customer query form. As described above, the customer can access an e-mail message from the merchant which includes a hyperlink for initiating an on-line meeting with a sales representative. In an alternative embodiment, a hyperlink for initiating an on-line meeting with a sales representative can be associated with a search result, or contained in a web page or any other suitable document. Further, the document can contain a script operative to analyze the customer's on-line activity, and to suggest to the customer that an on-line meeting with a sales representative might be in order. As described above, the customer can enter his or her personal identifying information, such as his or her name and the purpose of the on-line meeting or teleconference, into the customer query form. In an alternative embodiment, the query form can be pre-populated with information supplied as one or more parameters in the hyperlink for initiating the on-line meeting, or retrieved from a cookie previously stored on the customer computer. For example, a web page can contain multiple meeting request buttons with HTML defining each button and containing information uniquely defining the respective button, e.g., a product number associated with the respective button. Such HTML can be hand-coded or generated by a server-side script such as Microsoft Active Server Pages. As a result, a returning customer's name can be retrieved from a cookie and automatically entered on the query form, or, using the parameters in the hyperlink, a customer's area of interest or a product number can be automatically entered on the query form.

For example, a returning customer can access the web page of a merchant that sells consumer electronics to purchase a product such as a camcorder. If the customer wishes to communicate with a sales representative to discuss the camcorder product, then he or she can click on a hyperlink contained in the merchant's web page to initiate an on-line meeting with sales representative. In this case, the URL associated with the hyperlink can include a parameter containing the product number of the camcorder, and a cookie stored on the customer computer from a previous on-line session can contain the customer's name. In response to clicking on the hyperlink, a customer query form can open on the customer computer pre-populated with the customer's name and/or any other suitable account information, and information about the product of interest (e.g., the camcorder). The customer can then click on a button included in the query form to request an on-line meeting with a sales representative, and the query form including the customer's name and the other information can be automatically passed to the real-time messaging server to initiate the requested on-line meeting without further input from the customer.

As described above, the customer query form can be pre-populated with information supplied as one or more parameters in a hyperlink for initiating an on-line meeting or teleconference. In an alternative embodiment, such parameters can be contained in a document (e.g., an XML document) that is provided to the real-time communications system via an operation such as an HTTP POST. In one embodiment, these parameters can include a character string corresponding to the customer's name, telephone number, e-mail address, and/or any other suitable identifier for subsequent display within a window or toast, an identifier of a file or database record containing additional information about the customer or the particular transaction at hand, information to be passed to the on-line meeting or teleconference for subsequent display to one or more of the meeting participants, and/or information to be collected by the system for subsequent storage or processing. As described above, the information to be passed into an on-line meeting or teleconference need not be limited to text. For example, the customer can record an audio or video clip, which can then be played when a window or toast is displayed, or when the on-line meeting or teleconference is started.

The real-time communications system can employ the various parameters listed above, along with other parameters such as the IP address of the customer computer, to display text or other information to potential on-line meeting participants (e.g., sales representatives) to help them decide whether or not to accept a customer's request for an on-line meeting (e.g., the customer's name and/or previous purchasing history can be displayed to a sales representative), to provide an input to a software program operative to automatically match a customer's request for an on-line meeting with a sales representative(s) best suited to take part in the on-line meeting, to look up additional information in a database, to display text or other information for the purpose of identifying the participants of an on-line meeting (e.g., the customer name can be displayed in the title bar of a meeting window, and/or in a chat box before chat entries are supplied by the customer), to provide a contact identifier such as a telephone number, an e-mail address, or an instant messaging handle that can be used during or after an on-line meeting to allow further communication between the customer and the sales representative, and/or to customize an on-line meeting or teleconference (e.g., by selecting a suitable sales presentation to be displayed to the customer when the on-line meeting starts).

In addition, there are multiple ways of charging for the services provided by the real-time communications system, including but not limited to per on-line meeting, per meeting participant-minute, and subscription. For example, as in typical sales situations, the cost of providing an on-line meeting or teleconference can be born by the merchant or business doing the selling, but there are a number of ways such costs and other charges can be computed, including computing a flat charge for each on-line meeting or teleconference (e.g., each on-line meeting or teleconference can be limited to a specified duration), computing a charge per minute of an on-line meeting or teleconference, and/or providing a subscription entitling a sales organization to conduct a specified or unlimited number of on-line meetings or teleconferences per unit time. In addition, an on-line meeting or teleconference can be billed in arrears or sold as part of a pre-paid package of a specified number of on-line meetings or a specified number of minutes of on-line meetings. The price per on-line meeting or teleconference can also be fixed in advance, e.g., subject to a discount schedule, or the price can be determined by a reseller who pays a wholesale rate.

In addition, the charging for the services provided by the real-time communications system need not be directly related to the number or duration of on-line meetings or teleconferences convened via the system. For example, rights to include meeting links in on-line advertising campaigns (e.g., e-mail, search, banner, pop-up, etc.) can be licensed. In one embodiment, the number of on-line meetings or teleconferences can be unlimited, but the billing can be based upon the number of times an on-line advertisement was viewed (i.e., the number of “impressions”) or clicked on by a user. Licensing can also be provided on a fixed price basis per sales representative, either by named account or by the number of permitted simultaneous users. Such a licensing technique can be tied to a customer relationship management (CRM) system, in which the provisioning of a new sales representative on the CRM system would automatically give him or her the capability of holding on-line meetings or teleconferences.

In addition, it was described that a user of the real-time communications system such as a customer can enter personal identifying information on a query form, and that the customer query form can be pre-populated with information supplied as one or more parameters in the hyperlink for initiating an on-line meeting or teleconference, and/or information retrieved from a cookie previously stored on the customer computer. In an alternative embodiment, such parameters and other information can be passed into an on-line meeting or teleconference, and information generated during the on-line meeting (e.g., text chat, audio, video, the names of meeting participants, etc.), can be retained in the system for further processing. For example, data, parameters, and/or other information can be stored in a database or a log file, sent by e-mail to a specified logging mailbox, or stored in a external system such as a CRM system. Further, the customer can be asked to rate the quality of a sales experience and/or the service provided by a sales representative, to enter information relating to what transpired during an on-line meeting, and/or to provide an indication of what follow-up is required subsequent to the on-line meeting. Similarly, a sales representative can be asked to enter information about what transpired during an on-line meeting and an indication of what follow-up is required. During an on-line meeting or teleconference, a sales representative can use the data, parameters, and/or other information passed into the on-line meeting to look up other information contained in a database or a CRM system. For example, the salesperson computer can display a button that uses the name or e-mail address provided by the customer to look up, edit, and/or create a contact record in the CRM system, and to associate that contact record with a meeting record.

In addition, it was described that the real-time communications system 10 includes the voice response unit (VRU) and conference bridge 11, and the media server 18. In an alternative embodiment, the voice response unit (VRU) and conference bridge 11 and the media server 18 can be omitted from the system 10, and all data, voice, video, and other media traffic can be communicated peer-to-peer within the system.

In addition, it was described that the plurality of user systems 12 can include at least one telephone, and that the communications network 22 can include the PSTN. For example, in one embodiment, information provided via parameters in a meeting request can be displayed in a toast, followed by a telephone call to the user viewing the toast. In an alternative embodiment, the information displayed in the toast can be spoken to the user via the telephone (i.e., text-to-speech) if he or she were not currently in front of a computer.

In addition, a software program tool can be provided to aid in setting up one or more hyperlinks for initiating an on-line meeting or teleconference, and in setting up the query form. In one embodiment, the software program tool can be used to specify, for each hyperlink to be set up, the image and/or text to be displayed with the hyperlink, a unique identifier of the sales representative or lifeline to be contacted when a prospective customer clicks on the hyperlink, graphics and/or text to be displayed on the customer query form (e.g., for branding purposes), and the fields to be included on the query form. Further, for each field of the query form, the software program tool can be used to specify a default value, a parameter or cookie to be used to supply a value, a validation on input provided by the user, and actions to be performed based upon information and/or values entered on the query form. For example, such actions can include displaying specified information within a window or toast, and/or on the title line of a meeting window. The software program tool can also be used to specify the computers of the meeting participants on which the specified information is to be displayed. Moreover, the software program tool can be used in conjunction with an automated process such as an e-mail campaign manager to generate a large quantity of hyperlink URLs, automatically including one or more parameters in the hyperlinks to identify particular customers.

In addition, the real-time communications system can be configured to allow connections to third party applications, for example, to capture and retrieve information about prospective customers and/or on-line meetings or teleconferences. Further, the system can be configured to allow other participants to join an on-line meeting or teleconference after an on-line meeting or teleconference has begun using, for example, e-mail, instant messaging, or a lifeline.

It will be appreciated by those of ordinary skill in the art that further modifications to and variations of the above- described web-based system and method of establishing an on-line meeting or teleconference may be made without departing from the inventive concepts disclosed herein. Accordingly, the invention should not be viewed as limited except as by the scope and spirit of the appended claims.

What is claimed is:

1. A method of performing real-time communications involving a plurality of users over at least one communications network, each of said plurality of users being associated with a user system, at least one server system and each user system being communicably coupled to said communications network, comprising the steps of:
in a first receiving step, receiving, at said server system, a request for a real-time group action involving at least two of said plurality of users, said at least two of said plurality of users including a first user and at least one second user, said request for a real-time group action being associated with information pertaining to said first user;
in response to receiving said request for a real-time group action, generating at least one invitation to join said real-time group action, said at least one invitation including at least some of said information pertaining to said first user;
in a first sending step, sending said at least one invitation to join said real-time group action to said at least one second user;
in a second receiving step, receiving, at said user system associated with each of said at least one second user, said at least one invitation to join said real-time group action;
in a first determining step, determining, at said user system associated with each of said at least one second user, whether to accept said at least one invitation to join said real-time group action based at least in part upon at least some of said information pertaining to said first user; and
in a performing step, in the event said at least one invitation to join said real-time group action is accepted, performing said real-time group action.

2. The method of claim 1 further including, at said user system associated with said first user, accessing at least one document over said communications network, and entering said information pertaining to said first user on said document.

3. The method of claim 2 further including, in a second sending step, sending said document including said information pertaining to said first user to said server system.

4. The method of claim 1 further including, in a second sending step, sending said information pertaining to said first user to said server system, at least some of said information being included in at least one parameter associated with at least one hyperlink accessible at said user system associated with said first user.

5. The method of claim 1 wherein each of said first and second users has at least one condition associated therewith, a status of said condition being indicative of an availability of the respective user for participating in said real-time group action, wherein the availability of each of said first and second users is based at least in part upon a digital indication of an online presence of the respective user, and wherein said method further includes, in a second determining step, determining, at said server system, the status of said condition associated with said at least one second user.

6. The method of claim 5 further including, in a third determining step, determining whether said real-time group action can be performed based at least in part upon the status of said condition associated with said at least one second user, and wherein said performing step includes, in the event said real-time group action can be performed based at least in part on the status of said condition associated with said at least one second user, performing said real-time group action.

7. The method of claim 1 wherein said at least one second user comprises a plurality of second users, said plurality of second users being represented by an ordered list of said second users, and wherein said second receiving step includes receiving, at each user system associated with at least some of said plurality of second users, said at least one invitation to join said real-time group action.

8. The method of claim 7 wherein said first determining step includes determining, at said user system associated with one of said plurality of second users at the top of said ordered list, whether to accept said at least one invitation to join said real-time group action based at least in part upon at least some of said information pertaining to said first user.

9. The method of claim 8 further including, in a second determining step, in the event said at least one invitation to join said real-time group action is not accepted by said one of said plurality of second users at the top of said ordered list, determining, at said user system associated with a next one of said plurality of second users listed in said ordered list, whether to accept said at least one invitation to join said real-time group action based at least in part upon at least some of said information pertaining to said first user.

10. The method of claim 9 wherein said performing step includes, in the event said at least one invitation to join said real-time group action is accepted by at least one of said plurality of second users listed in said ordered list, performing said real-time group action.

11. The method of claim 9 further including, in the event said at least one invitation to join said real-time group action is not accepted by any of said plurality of second users listed in said ordered list, providing, at said user system associated with said first user, an indication that said plurality of second users is unavailable.

12. The method of claim 11 further including, in a second performing step, performing, at said user system associated with said first user, at least one of repeating said first sending step, waiting until at least one of said plurality of second users becomes available, and accessing at least one document over said communications network.

13. The method of claim 1 wherein said performing step includes exchanging, between said user systems associated with said first and second users, at least one message in at least one predetermined message format, said at least one predetermined message format including at least one of text, audio, and video.

14. The method of claim 1 further including, in the event said at least one invitation to join said real-time group action is accepted, providing a presentation for display at said user system associated with said first user, said presentation being based at least in part upon at least some of said information pertaining to said first user.

15. A system for performing real-time communications involving a plurality of users, comprising:
at least one communications network;
a plurality of user systems, each of said plurality of user systems being associated with a respective one of said plurality of users, each of said plurality of user systems being communicably coupled to said at least one communications network; and
at least one server system communicably coupled to said communications network, wherein said server system is operative:
to receive a request for a real-time group action involving at least two of said plurality of users, said at least two of said plurality of users including a first user and at least one second user, said request for a real-time group action being associated with information pertaining to said first user;
in response to receiving said request for a real-time group action, to generate at least one invitation to join said real-time group action, said at least one invitation including at least some of said information pertaining to said first user; and
to send said at least one invitation to join said real-time group action to said at least one second user,
wherein said user system associated with each of said at least one second user is operative:
to receive said at least one invitation to join said real-time group action; and
to determine whether to accept said at least one invitation to join said real-time group action based at least in part upon at least some of said information pertaining to said first user, and wherein said server system is further operative:
in the event said at least one invitation to join said real-time group action is accepted, to perform said real-time group action.

16. The system of claim 15 wherein said user system associated with said first user is operative to access at least one document over said communications network, and to entering said information pertaining to said first user on said document.

17. The system of claim 16 wherein said user system associated with said first user is further operative to send said document including said information pertaining to said first user to said server system.

18. The system of claim 15 wherein said user system associated with said first user is operative to send said information pertaining to said first user to said server system, at least some of said information being included in at least one parameter associated with at least one hyperlink accessible at said user system associated with said first user.

19. The system of claim 15 wherein each of said second users has at least one condition associated therewith, a status of said condition being indicative of an availability of the respective user for participating in said real-time group action, wherein the availability of each of said second users is based at least in part upon a digital indication of an online presence of the respective user, and wherein said server system is further operative to determine the status of said condition associated with said at least one second user.

20. The system of claim 19 wherein said server system is further operative to determine whether said real-time group action can be performed based at least in part upon the status of said condition associated with said at least one second user, and, in the event said real-time group action can be performed based at least in part on the status of said condition associated with said at least one second user, to perform said real-time group action.

21. The system of claim 15 wherein said at least one second user comprises a plurality of second users, said plurality of second users being represented by an ordered list of said second users, and wherein each user system associated with at least some of said plurality of second users is operative to receive said at least one invitation to join said real-time group action.

22. The system of claim 21 wherein said user system associated with one of said plurality of second users at the top of said ordered list is operative to determine whether to accept said at least one invitation to join said real-time group action based at least in part upon at least some of said information pertaining to said first user.

23. The system of claim 22 wherein said user system associated with a next one of said plurality of second users in said ordered list is operative, in the event said at least one invitation to join said real-time group action is not accepted by said one of said plurality of second users at the top of said ordered list, to determine whether to accept said at least one invitation to join said real-time group action based at least in part upon at least some of said information pertaining to said first user.

24. The system of claim 23 wherein said server system is further operative, in the event said at least one invitation to join said real-time group action is accepted by at least one of said plurality of second users listed in said ordered list, to perform said real-time group action.

25. The system of claim 23 wherein said server system if further operative, in the event said at least one invitation to join said real-time group action is not accepted by any of said plurality of second users listed in said ordered list, to provide, at said user system associated with said first user, an indication that said plurality of second users is unavailable.

26. The system of claim 25 wherein said user system associated with said first user is operative, in response to said indication that said plurality of second users is unavailable, to perform at least one of repeating said first sending step, waiting until at least one of said plurality of second users becomes available, and accessing at least one document over said communications network.

27. The system of claim 15 wherein said server system is further operative to exchange, between said user systems associated with said first and second users, at least one message in at least one predetermined message format, said at least one predetermined message format including at least one of text, image, audio, and video.

28. The system of claim 15 wherein said server system is further operative, in the event said at least one invitation to join said real-time group action is accepted, to provide a presentation for display at said user system associated with said first user, said presentation being based at least in part upon at least some of said information pertaining to said first user.
